(19) United States
(12) Patent Application Publication
(10) Pub. No.: US 2009/0010462 A1
(43) Pub. Date: Jan. 8, 2009

(54) COMPACT RECHARGEABLE THIN FILM BATTERY SYSTEM FOR HEARING AID

(75) Inventors: Leon EKCHIAN, Glendale, CA (US); Jeffrey Lynn ARIAS, Downey, CA (US); Weng-Chung Wang, Rowland Heights, CA (US); Kai Wei NIEH, Monrovia, CA (US)

Correspondence Address: JANAH & ASSOCIATES A PROFESSIONAL CORP, 650 DELANCEY STREET, SUITE 106, SAN FRANCISCO, CA, 941072001, US

(73) Assignee: Front Edge Technology, Inc.

(21) Appl. No.: 11/772,797

(22) Filed: Jul. 2, 2007

(51) Int. Cl. H02J 7/00; H04R 25/00

(52) U.S. Cl. 381/312; 320/137

(57) ABSTRACT

A rechargeable battery module for powering an external electronic device comprises a rechargeable thin film battery, a receiving induction coil, and a battery control circuit. The battery control circuit comprises a rectifier circuit, a battery charging circuit to limit the charging voltage provided by the direct current to the battery to a maximum charging voltage, and a battery discharging circuit to terminate a discharge voltage from the battery to less than a predetermined discharge voltage. A pair of output terminals to provide an output voltage to an external electronic device.

### BACKGROUND

Embodiments of the present invention relate to a rechargeable thin film battery system for electrical devices such as hearing aids.

Small and thin batteries have been extensively used as mobile power supplies for portable electronic devices such as mobile phones, PDA's, remote sensors, miniature transmitters; medical devices such as hearing aids, pacemakers, blood-pressure monitoring devices, and implantable medical devices; and other applications such as smart cards and MEMS devices, PCMCIA cards, and CMOS-SRAM memory devices. The batteries should have a sufficient electrical power capacity to power the electronic device reasonable length of time. The power capacity requirement can result in a battery which is quite heavy compared to the weight of the electronic device. Conventional batteries also often use potentially toxic materials that may leak out and are consequently subjected to extensive governmental regulation.

For example, hearing aids are typically powered by small disposable batteries which are zinc-air batteries. These small batteries have sizes ranging from size 675 for behind-the-ear units and cochlear implants with a diameter of 11.60 mm and height of 5.40 mm to even smaller size 5 batteries for hearing aids inserted into the ear canal, which have diameters of 5.75 mm and heights of 2.15 mm. However, these small disposable batteries have to be replaced quite often and the replacement process is difficult to perform and can create environmental problems. One reason why only approximately 20% of hearing impaired Americans use hearing aids is the often daunting task of frequently having to handle extremely small batteries, particularly for elderly patients. There are also substantial environmental issues created from the disposal of millions of zinc-air batteries.

To address this concern, hearing aid manufacturers have recently begun to consider the use of rechargeable batteries for their next generation products, such as NiMH batteries, which are recharged by removing the batteries from the hearing aid and inserting them into recharging units. While this addresses the environmental concerns associated with the disposal of zinc-air batteries, it does not obviate the need for having to frequently remove and reinstall the batteries, which may be as often as daily for high-power digital hearing aids. Aside from inconvenience of daily removal and installation of the batteries, the removal and reinstallation process also increases the likelihood of damaging delicate hearing aid components.

Another approach is to design hearing aids to allow for directly plugging the entire hearing aid into slots in suitably configured chargers. This overcomes the problem of having to remove and reinstall batteries. For example, rechargeable NiMH battery-powered hearing aids are plugged into recharging units after approximately 20 hours of use. However, such units require contacting the outer shell of the hearing aid for recharging, and one problem with this system is that moisture or water enters the hearing and through the exposed contact regions. Behind-the-ear models frequently become wet from perspiration or from rain and hearing aids installed within the ear canal that are not removed while taking a shower can get wet. Furthermore, the charger itself can short out when a wet hearing aid is plugged into the charger.

One solution to the problem of exposed contacts for rechargeable hearing aids is to inductively charge the hearing aid battery by coupling power between an external power source and a coil located internally to the device. However, such inductive chargers have their own set of difficulties, including adequate coupling between the primary inductor in the charger and the secondary inductor in the hearing aid; e.g. see U.S. Pat. No. 6,658,124 (Meadows). However, even with adequate coupling, conventional rechargeable batteries are not a panacea. For example, most rechargeable batteries such as for example nickel cadmium, and others, have a “memory” that relates the amount of stored energy to the number of discharging and charging cycles. For example, if half the energy is used up and a battery is recharged after that period, eventually, only half the energy is left available on the battery.

Another type of rechargeable battery which has also been used for portable devices include a lithium ion batteries. In this battery, the cathode is made from lithium and the electrolyte comprises lithium phosphoric oxide. These batteries provide a somewhat higher energy density and capacity. However, rechargeable batteries such as lithium ion batteries often overheat and rupture when being recharged. The overheated batteries can even catch fire and destroy the surrounding electronic device, or even be a hazard to the user. Consequently, lithium ion batteries and not extensively used, and nickel-metal-hydride (NiMH) batteries are preferred for hearing aids because they have fewer memory effects and are more tolerant of overcharging. The problems of memory and overcharging are particularly acute for hearing aids because a hearing aid may partially discharge a battery during the day and then be placed on a charger overnight. If more than one hearing aid is used, the batteries may be in different states of charge but are charged simultaneously.

Thus, it is desirable to have a power source that does not require frequent replacement or disassembly. It is also desirable to have a rechargeable power source that provides increased electrical energy specific capacity and density. It is further desirable to have a recharging system for the battery that is separable and can recharge the battery without being directly connected to electrical contacts of the battery.

### DRAWINGS

These features, aspects, and advantages of the present invention will become better understood with regard to the following description, appended claims, and accompanying drawings, which illustrate examples of the invention. However, it is to be understood that each of the features can be used in the invention in general, not merely in the context of the particular drawings, and the invention includes any combination of these features, where:

FIG. 1 is a schematic diagram of rechargeable battery module showing the rechargeable thin film battery, receiving induction coil, battery charging circuit and battery charger;

FIG. 2 is a schematic sectional side view of an embodiment of a thin film battery formed on a substrate;

FIG. 3 is a schematic top view of an embodiment of a thin film battery having multiple battery cells on a single substrate;

FIG. 4A is a schematic diagram of an embodiment of a battery charging circuit;

FIG. 4B is a schematic diagram of an embodiment of a step-down voltage converter circuit;

FIGS. 5A and 5B are schematic side and top views, respectively, of a shell for a rechargeable battery module;

FIG. 6 is a schematic diagram of a battery charger charging a rechargeable battery;

FIG. 7 is a perspective view of a battery charger capable of receiving and simultaneously charging more than one rechargeable battery module; and

FIGS. 8A and 8B are schematic perspective views of a hearing aid comprising a rechargeable battery module mounted therein.

### DESCRIPTION

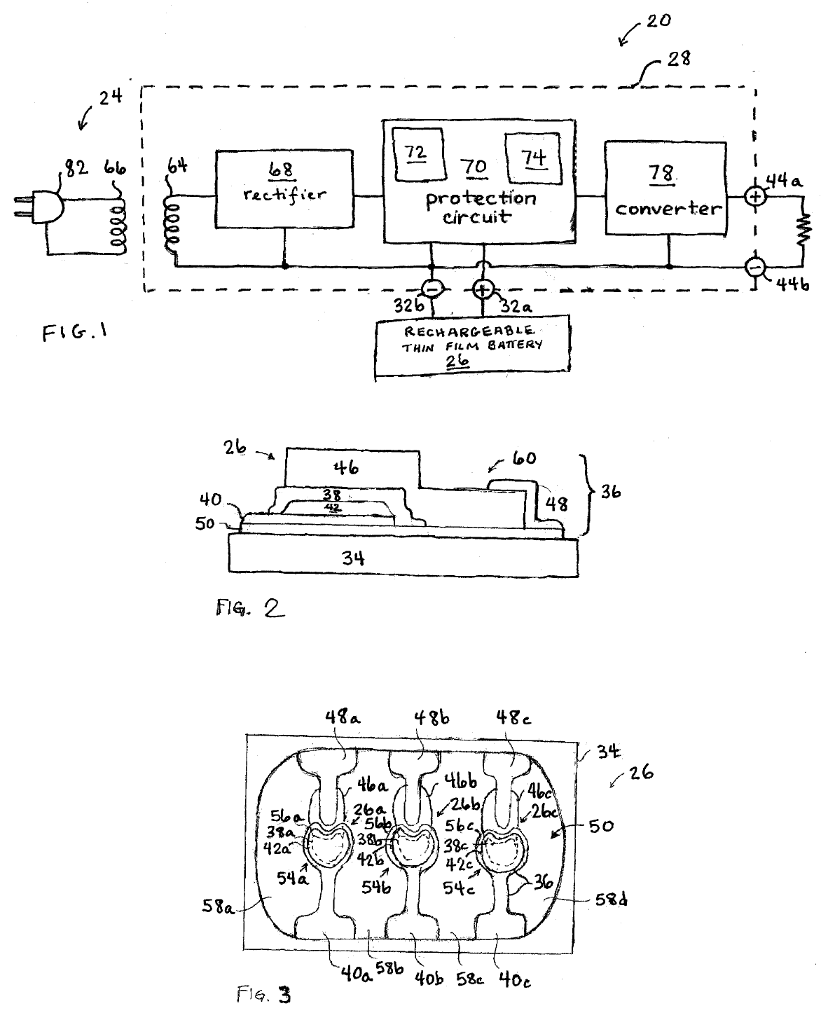

An embodiment of a rechargeable battery assembly comprising a rechargeable battery module 20 to provide power to a portable electronic device, and an external battery charger 24, is shown in FIG. 1. The rechargeable battery module 20 comprises a rechargeable thin film battery 26 and a battery control circuit 28. Generally, the rechargeable thin film battery 26 is fabricated on a substrate and enclosed by a protective coating. The battery control circuit 28 is capable of safely discharging and charging the rechargeable battery without damaging the battery. The entire rechargeable battery module 20 may be enclosed by a protective housing 30 that includes external terminals 32a,b to connect and provide electrical power to an external electronic device and/or the rechargeable battery module 20 can be built inside the housing of the electronic device itself.

An embodiment of a rechargeable thin film battery 26 suitable for the battery module 20 is shown in FIG. 2. The thin film battery 26 comprises a substrate 34 having a plurality of battery component films 36 on one or more surfaces of the substrate 34, for example, on the front surface of the substrate (as shown) as well as in the back surface of the substrate (not shown). The substrate 34 is a dielectric having sufficient mechanical strength to support battery component films 36 and a smooth surface for deposition of thin films. Suitable substrates 34 can be made from, for example, ceramic oxides such as aluminum oxide or silicon dioxide; metals such as titanium and stainless steel; semiconductors such as silicon; or even polymers. One desirable substrate 34 comprises a crystalline sheet formed by cleaving the planes of a cleavable crystalline structure. The crystalline cleaving structure can be, for example, mica or graphite. Mica can be split into thin crystal sheets having thicknesses of less than about 100 microns or even less than about 25 microns, as described in commonly assigned U.S. Pat. No. 6,632,563 “THIN FILM BATTERY AND METHOD OF MANUFACTURE”, filed on Sep. 9, 2000, which is incorporated by reference herein and in its entirety. Battery performance measures such as energy density and specific energy are improved by forming the battery on the thin plate-like substrates 34 of mica which increase the energy to volume/weight ratio of the battery.

The battery component films 36 can be employed in a number of different arrangements, shapes, and sizes, and they cooperate to form a battery to receive, store, and discharge electrical energy. The battery component films 36 include at least a pair of electrode films with an electrolyte film 38. The electrode films can include one or more of a cathode current collector film 40, a cathode film 42, an anode film 46, and an anode current collector film 48, which are all inter-replaceable. For example, the battery 26 can include (i) a pair of cathode and anode films or a pair of current collector films, (ii) both the anode/cathode films and the current collector films, or (iii) various combinations of these films, for example, a cathode film and an anode and anode current collector film but not a cathode current collector film, and so on. The exemplary versions of the battery 26 illustrated herein are provided to demonstrate features of the battery 26 and to illustrate their processes of fabrication; however, it should be understood that the exemplary battery structures should not be used to limit the scope of the invention, and alternative battery structures as would be apparent to those of ordinary skill in the art are within the scope of the present invention. The battery component films 36 are typically less than 100 microns allowing the thin film batteries to be less than about 1/100^{th} of the thickness of conventional batteries. The battery component films 36 are formed by processes, such as for example, physical and chemical vapor deposition (PVD or CVD), oxidation, nitridation, and electroplating.

In one version, as shown in FIG. 2, the battery 26 comprises a plurality of battery component films 36 formed on an adhesion layer 50. The adhesion film 50 can comprise a metal or metal compound, such as for example, aluminum, cobalt, titanium, other metals, or their alloys or compounds thereof; or a ceramic oxide such as, for example, lithium cobalt oxide. The adhesion film 50 is deposited in a thickness of from about 100 to about 1500 angstroms. A cathode current collector film 40 is formed on the adhesion film 50 to collect the electrons during charge and discharge process. The cathode current collector film 40 is typically a conductor and can be composed of a metal, such as aluminum, copper, platinum, silver or gold. The current collector film 40 may also comprise the same metal as the adhesion film 50 provided in a thickness that is sufficiently high to provide the desired electrical conductivity. A suitable thickness for the first current collector film 40 is from about 0.05 microns to about 2 microns. In one version, the first current collector film 40 comprises platinum in a thickness of about 0.2 microns. The cathode current collector film 40a-c can be formed as a pattern of features 54a-c, as illustrated in FIG. 3, that each comprise a spaced apart discontinuous region that covers a small region of the adhesion film 5. The features 54a-c are over the covered regions 56a-c of the adhesion film 50, and adjacent to the features 54a-c are exposed regions 58a-c of the adhesion film 50. After forming the features 54a-c on the adhesion film 50, the adhesion film 50 with its covered regions 56a-c below the patterned features 54a-c and exposed surface regions 58a-d, is then exposed to an oxygen-containing environment and heated to oxidize the exposed regions 58a-d of titanium that surround the deposited platinum features but not the titanium regions covered and protected by the platinum features. The resultant structure, advantageously, includes not only the non-exposed covered regions 56a-c of adhesion film 50 below the features 54a-c of the current collector film 48, but also oxygen-exposed or oxidized regions 58a-d which form non-conducting regions that electrically separate the plurality of battery cells 60a-c formed on the same substrate 34.

The cathode film 42 comprises an electrochemically active material is then formed over the current collector film 40. In one version, the cathode film 42 is composed of lithium metal oxide, such as for example, lithium cobalt oxide, lithium nickel oxide, lithium manganese oxide, lithium iron oxide, or even lithium oxides comprising mixtures of transition metals such as for example, lithium cobalt nickel oxide. Other types of cathode films 42 that may be used comprise amorphous vanadium pentoxide, crystalline V₂O₅ or TiS₂. Typically, the cathode film stack has a thickness of at least about 5 microns, or even at least about 10 microns. In one example, the cathode film 42 comprises crystalline lithium cobalt oxide, which in one version, has the stoichiometric formula of LiCoO₂.

An electrolyte film 38 is formed over the cathode film 42. The electrolyte film 38 can be, for example, an amorphous lithium phosphorus oxynitride film, also known as a LiPON film. In one embodiment, the LiPON has the stoichiometric form LiₓPO_{y}N_{z} in an x:y:z ratio of about 2.9:3.3:0.46. In one version, the electrolyte film 38 has a thickness of from about 0.1 microns to about 5 microns. This thickness is suitably large to provide sufficiently high ionic conductivity and suitably small to reduce ionic pathways to minimize electrical resistance and reduce stress.

An anode film 46 formed over the electrolyte film 38. The anode film 46 can be the same material as the cathode film 42, as already described. A suitable thickness is from about 0.1 microns to about 20 microns. In one version, anode film 46 is made from lithium which is also sufficiently conductive to also serve as the anode current collector film 48, and in this version the anode film 46 and anode current collector film 48 are the same. In another version, the anode current collector film 48 is formed on the anode film 46, and comprises the same material as the cathode current collector film 40 to provide a conducting surface from which electrons may be dissipated or collected from the anode film 46. For example, in one version, the anode current collector film 48 comprises a non-reactive metal such as silver, gold, platinum, in a thicknesses of from about 0.05 microns to about 5 microns.

After the deposition of all the battery component films 36, a protective coating is formed over the battery component films 36 to provide protection against environmental elements. In one example, the protective coating comprises a plurality of polymer and ceramic layers that are superimposed on each other. Portions of the cathode current collector film 40 and anode current collector film 48 that extend out from under a battery cell 60 form a pair of terminals that is used to connect the battery cell 60 of the battery 26 to the external environment.

The embodiment of the rechargeable thin film battery 26 described herein provides a higher energy storage capacity, energy density, and specific energy level, than conventional solid state batteries. The thin film battery 26 is typically less than about 1/100th of the thickness of conventional batteries and can be formed by thin film fabrication processes, such as for example, physical or chemical vapor deposition methods (PVD or CVD), oxidation, nitridation or electroplating. Advantageously, the thin film battery 26 described herein provides significantly higher specific energy capacity and energy density than conventional thin film batteries. The energy density level is the fully charged output energy level per unit volume of the battery. The specific energy level is the fully charged output energy level per unit weight of the battery. Conventional thin film batteries have large sizes and are heavier, and consequently, have maximum energy density levels of 200 to 350 W-hr/l and specific energy levels of 30 to 120 W-hr/L. However, the thin film battery described has an energy density level exceeding 300 W-hr/L.

The rechargeable thin film battery 26 is charged by a receiving induction coil 64 and electrically coupled to a battery control circuit 28 as shown in FIG. 3. The receiving induction coil 64 draws power from an external transmission induction coil 66 located in a battery charger 24. Typically, the receiving induction coil 64 is located adjacent to, and is electrically coupled to the terminals 32a,b of the thin film battery 26 and the battery control circuit 28. The receiving induction coil 64 comprises a coil of electrically conducting wire, such as copper wire, having a number of turns that is selected based on the induction voltage desired to be induced in the coil 64. A suitable receiving induction coil 64 comprises from about 100 to even over 1000 turns.

In one version, the receiving induction coil 64 comprises a first induction coil 64a having a first central axis oriented along a first direction, and a second induction coil 64b having a second central axis oriented along a second direction that is a different direction than the first direction. As result, the first and second coils 64a,b are positioned in different planes. For example, the second induction coil 64b can have a second central axis that is oriented perpendicular to the first central axis of the first induction coil 64a. This allows the receiving induction coil 64 to receive a voltage even if the coil 64 is misaligned with the transmission induction coil 66 of a battery charger 24. In one version, the first and second induction coils 64a,b each comprise from about 100 to about 1000 turns, each turn comprising an area of between about 1 and about 30 mm².

The battery control circuit 28 receives electrical power from the receiving induction coil 64 and controls charging and discharging of the battery 26. The battery control circuit 28 can have one or more optional sub-circuits, which can include a rectifier circuit 68, battery protection circuit 70 comprising a battery charging circuit 72 and a battery discharging circuit 74, and a voltage converter circuit 78, which can be a step-down or step-up circuit to suite the voltage output requirements.

The rectifier circuit 68 is coupled to the receiving induction coil 64 and serves to convert the coil's AC current to a DC current for direct charging of the battery 26. The rectifier circuit 68 is capable of converting an AC voltage of between about 3.2 and 21 Volts at a frequency of about 60 Hz or above to a DC voltage of between about 4.5 and 30 volts or even between about 4.5 and 5 volts. The rectifier circuit 68 can comprise a diode bridge rectifier that is connected between a terminal of the receiving induction coil 64 and the load. A capacitor can be provided in parallel with the load so as to smooth the rectified wave form. Alternately, the rectifier circuit 68 can comprises an integrated circuit (IC) chip. In one prospective embodiment the rectifier circuit 68 is integrated with the battery protection circuit 70 as in the case of an integrated control circuit 28.

The battery protection circuit 70 comprises two different sub-circuits, namely a battery charging circuit 72 and a battery discharging circuit 74, and the sub-circuits may be separate circuits or maybe combined into a single operable circuit. The battery charging circuit 72 protects the battery from overcharging by limiting the maximum charging voltage to a value that is below a maximum charging voltage value. In one application, the battery charging circuit 72 limits the maximum charging voltage to the value of less than about 4.2 volts during charging. In addition, the battery charging circuit 72 can also limit the maximum amperage provided to charge the battery. The battery charging circuit 72 prevents over threshold charging voltages, which can damage the battery 26, or cause the battery to heat up to a temperature that is sufficiently high to damage the battery. The battery charging circuit 72 is particularly useful when the rechargeable battery module 20 is misaligned during insertion to a misaligned position which results in a higher voltage being inductively transmitted from an external transmission induction coil 66 to the receiving induction coil 64. Providing a battery charging circuit 72 that is integral with the battery recharging module 20, allows the module 20 to be misaligned on a battery charger without adverse effects.

The battery protection circuit 70 can also include a battery discharging circuit 74 that controls the discharge of current from the battery 26. The battery discharging circuit 74 protects the battery 26 from excessive or over-discharge by shutting of or terminating the discharge voltage from the battery 26 when the battery voltage reaches a predetermined minimum voltage level that is predetermined and is based on the capacity of the battery. For example, the minimum voltage level for a thin film battery 26 as described above can be about 3.4 Volts.

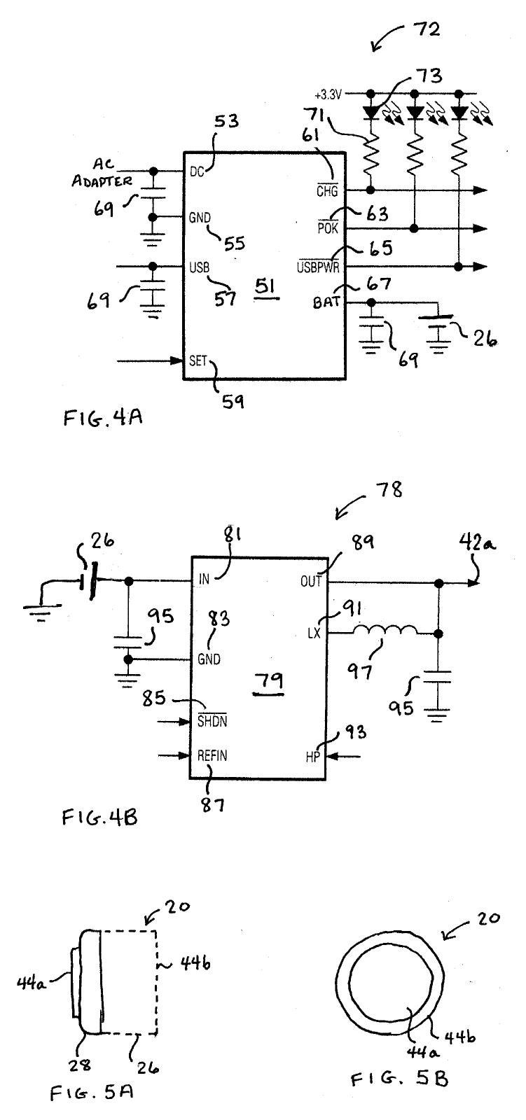

In one exemplary embodiment the charging circuit 72 comprises an adapter charger IC chip 51, such as for example, a MAX8804Y or MAX8804Z integrated circuit (IC) chip available from Maxim Integrated Products, of Sunnyvale, Calif. The adapter charger IC chips 51 are dual-input, stand-alone, constant-current, constant-voltage, thermally regulated linear charger that were developed for lithium ion batteries. The IC chips 51 include a current-sensing circuit, MOS pass element, thermal-regulation circuitry, and over voltage protection. The IC chip 51 is capable of serving as a stand-alone charger to control the charging sequence from the prequalification state through the fast-charge, top-off charge, and full charge indication. As shown in FIG. 4A, the adapter charger IC chip 51 comprises a DC port 53, a ground port 55, a USB port 57, a SET port 59, a charging-status port (CHG) 61, a POK port 63, a USB power port 65, and a battery port 67. The IC chip 51 provides an adjustable DC/USB passed-charge current through the SET port 59. The charger automatically selects between either a USB or AC adapter input source. The AC adapter charge current is programmable from 400 milliamps to 700 milliamps through 50 milliamps steps through a serial interface. The USB charge current is programmable to 95 milliamps, 380 milliamps, or 475 milliamps. The CHG charging status indicator indicates an active-low battery charging status, the POK port 63 indicates an active-low power-OK indicator status, and the USB power port 65 indicates active-low USB input detection output. The IC chip accepts a 4.15 to 30 V DC source voltage or a 4.15 to 16 V USB input voltage, but disables charging if either input voltage exceeds 7.5 volts. The various ports of the adapter charger IC chip 51 are connected to circuit components that include various capacitors 69, resistors 71 and photodiodes 73, which are arranged to provide an appropriate controlled DC output voltage to the battery 26 as shown in FIG. 4A. While an embodiment of an adapter circuit IC chip 51 is shown and described to illustrate the present circuit, it should be understood that other adapter circuit IC chips, or alternative battery charging circuits, can be used as would be apparent to one of ordinary skill in the art.

In one prospective embodiment the battery protection circuit 70 comprises an integrated circuit which serves as both the charging circuit 72 and the discharging circuit 74. Custom integrated battery protection circuits are readily available and one such circuit comprises, for example, an S-8211 C integrated circuit available from Seiko Instruments, Chiba, Japan.

The voltage converter circuit 78 is provided to receive the voltage of the thin film battery 26 and to output a pre-determined voltage value between the output terminals 44a,b. In one embodiment the voltage converter circuit 78 is a step-down circuit that steps the voltage of the thin film battery 26 down to provide a conventional lower voltage between the output terminals. In one embodiment the voltage converter circuit receives a voltage of the thin film battery that is between about 3.3 and 4.3 Volts and outputs a voltage between the output terminals of about 1.2 Volts at a current draw of about 20 mA. A suitable voltage converter circuit 78 comprises, for example, a MAX8581 or MAX8582 step-down converter integrated circuit (IC) chip 79 available from Maxim Integrated Products, Sunnyvale, Calif., USA. The voltage converter IC chips 79 are step-down converters that can receive the battery voltage of between 2.7 and 5.5 V and output an adjustable voltage level that can be set between a low of about 0.4 V up to the voltage of the battery. The MAX8581 and MAX8582 are additionally equipped with thermal shutdown circuitry that will automatically shut down current flow through the chip above about 160° C. As shown in FIG. 4B, the voltage converter IC chip 79 comprises a battery port 81, a ground port 83, a shutdown port 85, a reference input port 87, an output port 89, an LX port 91 and a forced bypass port 93. The various ports of the voltage converter IC chip are connected to circuit components that include various capacitors 95, and inductors 97, which are arranged to provide an appropriate controlled DC output voltage to an output terminal 42a of the rechargeable battery module 20 as shown in FIG. 4B. While an embodiment of a voltage converter IC chip is shown and described to illustrate the present circuit, other voltage converter circuits 78 having the appropriate characteristics are available, for example, custom SOIC DC-DC converter chips can be obtained from Advanced Analogic Tech, Inc., Sunnyvale, Calif., USA and it should be understood that other voltage converter IC chips, or alternative step down converter circuits, can be used as would be apparent to one of ordinary skill in the art.

A rechargeable battery assembly comprises the rechargeable battery module 20 and a battery charger 24. The battery charger 24 receives the rechargeable battery module 20 (or the electronic device containing the module) and provides power to be coupled to the receiving induction coil 64 of the battery module 20 to provide electrical power to recharge the battery 26. The battery charger 24 comprises an external housing 80 enclosing transmission induction coil 66. The transmission induction coil 66 is powered by a voltage transforming circuit 82 which connects to an external power supply 84 to provide an alternating voltage to the transmission induction coil 66. In one embodiment the alternating voltage that is supplied to the transmission induction coil 66 has a frequency of between about 50 kHz and about 5 MHz or even between about 200 kHz and about 2 MHz. The external housing 80 comprises a receiving surface 88 to receive the rechargeable battery module 20. The battery charger 24 can output a power to the recharging battery assembly of up to about 10 Watts when connected to an outside power source comprising an AC power source of about 60 hz and about 120V.

In one embodiment, the charger 24 comprises a flat surface for placement of the rechargeable battery module 20, or an electronic device containing the rechargeable battery module 20, thereon. In this version, the battery charger 24 also has a support bracket 90 surrounding its receiving surface 88 to hold and support the rechargeable battery module 20 (or the electronic device containing the rechargeable battery module 20) to properly orient the module/device for optimal power coupling between the battery charger 24 and the rechargeable battery module 20. A suitable support bracket 90 comprises an internal profile that matches the external shape of the rechargeable battery module 20 or electronic device. In another embodiment the receiving surface 88 is shaped to conform to the enclosure about the rechargeable battery module 20 thereby allowing the module 20 to be firmly seated thereon.

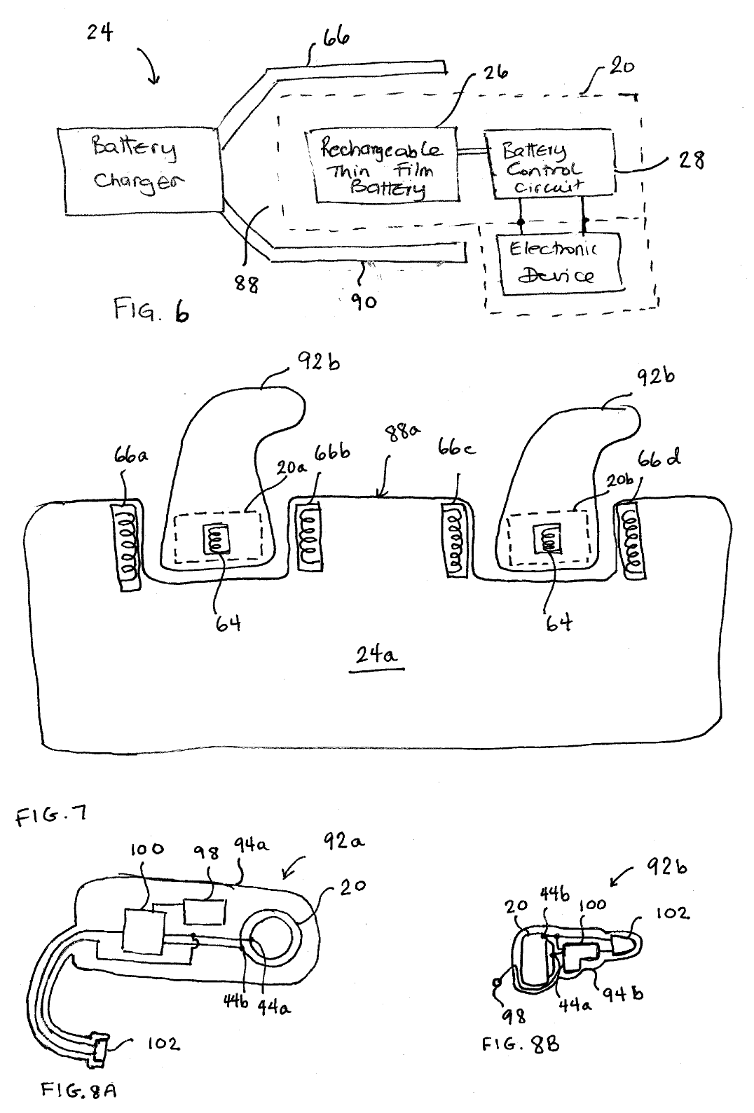

In another embodiment, the battery charger 24 comprises a transmission induction coil 66 that is located inside the charger casing about the shaped receiving surface 88 thereby allowing for partial insertion of the rechargeable battery module 20 or electronic device therein, as shown in FIG. 6. This shaped internal profile allows automatic alignment of the receiving induction coil 64 with the charger 24 to properly orient the receiving induction coil 64 for optimal power coupling between the battery charger 24 and the rechargeable battery module 20.

In a further embodiment, as shown for example in FIG. 7 the charger 24a comprises a shaped receiving surface 88a that is capable of receiving more than one rechargeable battery module 20a,b and a plurality of transmission induction coils 66a-d. Because the battery modules 20a,b each contain a charge controller, it is not necessary to equip the multiple unit charger 24a with separate charge control circuitry for independently controlling the charging of each device.

The voltage transforming circuit 82 is provided to convert an AC line voltage to a voltage and current suitable for driving the transmission induction coil 66. In one version, the voltage transforming circuit 82 comprises a transformer.

The rechargeable battery module 20 can be used in a number of different electronic devices. For example, the rechargeable battery module 20 can be used as a mobile power supply for portable electronic devices such as mobile phones, satellite phone, personal digital assistants, remote sensors, miniature transmitters, smart cards, MEMS devices, PCMCIA cards, and CMOS-SRAM memory devices. The rechargeable battery module 20 also has extensive applications for external and implantable medical devices such as hearing aids, pacemakers, blood-pressure monitoring devices, and neural stimulators. The rechargeable battery module 20 is designed to fit any one of these requirements by providing a sufficient electrical power capacity to power the electronic device for a reasonable length of time that can vary with the type of electronic device.

In one application, the rechargeable battery module 20 is used to provide rechargeable power for an external hearing aid. In this version, the rechargeable battery module 20 comprises a thin film rechargeable battery 26 and circuits designed to allow the battery module 20 to provide an electrical power output that is equivalent to the power output provided by non-rechargeable hearing aid batteries such as zinc-air batteries. The rechargeable battery module 20 can also be made to have external dimensions that are the same as conventional hearing aid batteries to allow ready replacement and interchangeability of a hearing aid battery with the rechargeable battery module 20. For example, the rechargeable battery module 20 can be enclosed by a housing 40 which provides a protective enclosure and has output terminals 42a,b for connecting the rechargeable battery module 20 to an external electronic device. A suitable housing 40 comprises a cylindrical metal housing 42 as shown in FIG. 5A and 5B. The cylindrical shell can also be shaped and sized to replace disposable, non-rechargeable, or other rechargeable batteries currently used in electronic devices. For example, the housing 40 can be sized to replace a hearing aid battery having first size such as a Size 675 for hearing aides behind-the-ear units or cochlear implants, the first size corresponding to a diameter of 11.60 mm and height of 5.40 mm; or a second size such as a Size 5 for hearing aids, which are positioned entirely in the ear canal, the second size corresponding to a diameter of 5.75 mm and height of 2.15 mm.

In one version, the rechargeable battery module 20 is designed and shaped to replace currently used zinc-air batteries and to provide an operating voltage of about 1.3 V. In this version, the voltage provided by the thin film rechargeable battery 26 has to be stepped down to convert the voltage to value from 4.2 volts to 1.3 volts. This would allow for the direct replacement of non-rechargeable batteries currently used in hearing aids with such battery modules 20. The battery modules 20 can then be inductively recharged without requiring their frequent removal from the hearing aid.

Embodiments of a hearing aid 92 comprising a rechargeable battery module 20 is shown in FIG. 8A and 8B. The hearing aid 92 comprises a casing 94 to protect and enclose a microphone 98, signal processor 100, and a speaker 102. The microphone 98 receives an external sound wave and generates a corresponding signal. The microphone 98 can comprise a vibratory diaphragm that is coupled to a coil to generate an electrical current. The signal output of the microphone is connected to the input of the signal processor 100.

The signal processor 100 receives the signal from the microphone 98 and outputs a modified electrical signal to power the speaker 102. The signal processor 100 typically comprises an amplifier to receive an electrical signal from the microphone 98 and output a modified electrical signal. The amplifier is coupled to a computer chip comprising operable analytical code to control the amplifier. The signal processor 100 amplifies components of the signal and can selectively amplify certain frequencies or ranges of frequencies. In several versions the signal processor 100 can be adjusted to selectively amplify certain frequencies or ranges of frequencies that correspond to the individual impairment of the wearer. The signal output of the signal processor 100 is connected to the input of the speaker 102.

The speaker 102 outputs a modified sound signal to the ear of the wearer. The speaker 102 receives the modified electrical signal from the signal processor 100 and outputs a sound signal.

The casing 94 provides a protective enclosure and mounting structure for the components of the hearing aid 92. The shape of the casing 94 is determined depending on the type of hearing aid and requirements of the wearer. For example, the casing 94 can comprise a flat rectangular casing 94a as in for “behind-the-ear” (BTE) hearing aids 92a, as shown for example in FIG. 8A. In another version, the casing 94 can be a molded compact casing 94b for “in-ear” hearing aids 92b, which are placed directly in the ear of the wearer, as shown for example in FIG. 8B. A variety of in-ear hearing aids are available, such as “in-the-ear” (ITE), “in-the-canal” (ITC) or even “completely in the canal” (CIC) hearing aids. The casing 94a of the BTE style hearing aid 92a typically comprises a plastic whereas the casing 94b of the in-ear style hearing aids 92b typically comprise a molded plastic or a rubber. In many in-ear styles, the casing 94b is molded to conform to the unique shape of the individual wearer's ear. The casing 94 can also have a compartment 104 for the mounting of a battery 26. The compartment 104 can include a flap for access to or removal of the battery 20 or can be sealed as in the case with some rechargeable models.

While illustrative embodiments of the rechargeable battery module 20 are described in the present application, it should be understood that other embodiments are also possible. For example, alternative thin film battery designs and configurations can be used within the rechargeable battery module 20. Also, the rechargeable battery module 20 can be packaged with an electronic device to save space while still providing a hermetic seal around the battery. Thus, the scope of the claims should not be limited to the illustrative embodiments described herein.

What is claimed is:

1. A rechargeable battery module to power an external electronic device, the battery module comprising:
(a) a rechargeable thin film battery comprising:
(i) a substrate having a thickness of less than about 100 microns;
(ii) a plurality of battery component films on the substrate, the battery component films including at least a pair of electrode films about an electrolyte film, the electrode films comprising one or more of a cathode current collector film, cathode film, anode film, and anode current collector film; and
(iii) battery terminals connected to the pair of electrode films;
(b) a receiving induction coil electrically coupled to the battery terminals;
(c) a battery control circuit electrically coupled to the receiving induction coil and the battery terminals, the battery control circuit comprising:
(i) a rectifier circuit electrically coupled to the receiving induction coil to convert an alternating current that is generated within the coil to a direct current for charging the battery;
(ii) a battery charging circuit to limit the charging voltage provided by the direct current to the battery to a maximum charging voltage; and
(d) a pair of output terminals to provide an output voltage to an external electronic device.

2. A battery module according to claim 1 wherein the substrate comprises mica.

3. The rechargeable battery module of claim 1 wherein the battery control circuit further comprises:
(iii) a battery discharging circuit to terminate a discharge voltage from the battery when the discharge voltage reaches a predetermined minimum discharge voltage.

4. A battery module according to claim 1 comprising at least one of the following:
(1) an anode or cathode film comprising lithium cobalt oxide, lithium nickel oxide, lithium cobalt nickel oxide, amorphous vanadium manganese pentoxide, crystalline iron V₂O₅ or TiS₂; and
(2) an anode or cathode current collector film comprise aluminum, copper, platinum, silver or gold.

5. A battery module according to claim 1 wherein the electrolyte comprises lithium phosphorous oxynitride, the cathode comprises lithium cobalt oxide, and the anode comprises lithium.

6. A battery module according to claim 1 further comprising a protective coating about the rechargeable battery, the protective coating comprising a plurality of polymer and ceramic layers superimposed on each other.

7. A battery module according to claim 1 comprising a plurality of rechargeable battery cells.

8. A battery module according to claim 1 wherein the receiving induction coil comprises between about 100 and about 1000 turns.

9. A battery module according to claim 1 wherein the rectifier circuit comprises a diode and a capacitor.

10. A battery module according to claim 1 wherein the battery charging circuit is adapted to limit the charging voltage to a maximum charging of about 4.2 volts.

11. A battery module according to claim 3 wherein the battery discharging circuit terminates the discharge voltage from the battery when the discharge voltage reaches a voltage of about 3.4 volts.

12. A battery module according to claim 1 further comprising a voltage converter circuit comprising a step-down voltage circuit.

13. A battery module according to claim 12 wherein the step-down voltage circuit provides a stepped down voltage ratio of from about 1.1 to about 4.5.

14. A battery module according to claim 12 wherein the step-down voltage circuit is capable of stepping down an input voltage of between about 2.5 and 4.5 Volts to an output voltage of about 1.2 volts.

15. A rechargeable battery assembly comprising the rechargeable battery module of claim 1 and a battery charger, the battery charger comprising:
(1) an external housing comprising a receiving surface to receive and conform to the enclosure of the rechargeable battery module or electronic device;
(2) a transmission induction coil in the external housing; and
(3) a voltage transforming circuit for connecting to an external power supply to provide an alternating voltage to the transmission induction coil.

16. A battery assembly according to claim 15 further comprising a support bracket for surrounding the receiving surface of the external housing.

17. A battery assembly according to claim 15 wherein the transmission induction coil outputs a power of up to about 10 watts.

18. A rechargeable hearing aid comprising:
(a) a housing;
(b) a rechargeable battery module in the housing;
(c) a microphone to convert ambient sound into an electrical signal;
(d) a signal processor to receive the signal from the microphone and output a modified electrical signal; and
(e) a speaker to receive the modified electrical signal from the signal processor and output a sound wave.

19. A hearing aid according to claim 19 wherein the rechargeable battery module comprises:
(1) a rechargeable thin film battery comprising:
(i) a substrate having a thickness of less than about 100 microns;
(ii) a plurality of battery component films on the substrate, the battery component films including at least a pair of electrode films about an electrolyte film, the electrode films comprising one or more of a cathode current collector film, cathode film, anode film, and anode current collector film; and
(iii) battery terminals;
(2) a receiving induction coil electrically coupled to the battery terminals;
(3) a battery control circuit electrically coupled to the receiving induction coil and the battery terminals, the battery control circuit comprising:
(i) a rectifier circuit electrically coupled to the receiving induction coil to convert an alternating current that is generated within the coil to a direct current for charging the battery;
(ii) a battery charging circuit to limit the charging voltage provided by the direct current to the battery to a maximum charging voltage; and
(ii) a battery discharging circuit to terminate a discharge voltage from the battery when the discharge voltage reaches a predetermined minimum discharge voltage; and
(4) a pair of output terminals to provide an output voltage to an external electronic device.

20. A hearing aid according to claim 20 wherein the substrate comprises mica.
